(19) United States
(12) Patent Application Publication
(10) Pub. No.: US 2013/0278488 A1
(43) Pub. Date: Oct. 24, 2013

(54) DISPLAY PANEL HAVING NON-UNIFORM PIXEL DISTRIBUTION DENSITY

(71) Applicant: Hung-Lung Huo, Shenzhen (CN)

(72) Inventor: Hung-Lung Huo, Shenzhen (CN)

(73) Assignee: SHENZHEN CHINA STAR OPTOELECTRONICS TECHNOLOGY CO. LTD., Shenzhen (CN)

(21) Appl. No.: 13/522,703

(22) PCT Filed: Apr. 23, 2012
(86) PCT No.: PCT/CN12/74542

§ 371 Date: Jul. 17, 2012

(30) Foreign Application Priority Data
Apr. 19, 2012 (CN) 201210116206.1

(51) Int. Cl. G06T 17/00; G09G 3/36

(52) U.S. Cl. CPC G06T 17/00; G09G 3/36
USPC 345/87

(57) ABSTRACT

A display panel is disclosed. The display panel is divided into a central region and a peripheral region. The central region is located at a central position of the display panel. The central region is extended outward from the central position and occupies a predetermined area. The peripheral region surrounds the central region. It is noted that distribution density of the pixels located in the central region is greater than that of the pixels located in the peripheral region. The present invention can solve the problem of circuit instability caused by disposing a large number of pixels on a high-resolution display panel.

### TECHNICAL FIELD OF THE INVENTION

The present invention relates to a display panel, and more particularly, to a display panel having non-uniform pixel distribution density.

### BACKGROUND OF THE INVENTION

Liquid crystal display (LCD) panels become a mainstream of television (TV) panels. To satisfy the needs of human visual perception, the display panels are gradually improved. For example, the response time of liquid crystal molecules is reduced for achieving a better dynamic video effect; the occurrence of dark-state light leakage of the display panel is minimized for improving contrast; and the problems of color cast and contrast have to be solved for improving the image quality of wide viewing angle display products.

Recently, the resolution of TV panel is significantly enhanced. There are three versions: high definition (HD, 1366×768) at early times, full high definition (FHD, 1920×1080), and 4K resolution (4K×2K) that has been developed currently. When the resolution of display panel becomes higher, the image performance becomes more delicate and more like a real object, in addition, the image quality of the display panel is increased as well.

To improve the experience as if it were really happening, a user usually shortens a distance for view so as to enlarge the viewing angle. However, it has to shrink the pixel size of the display panel to prevent the user from seeing coarse images. This is because human eyes possess a certain resolution or visual ability (or called visual sensibility), that is, an ability to clearly identify two lines or two points. In general, this ability is represented by an angle formed between the two closest distinguishable lines (or points) to the human eyes. The visual sensibility of human eyes is about one minute, i.e., 1/60 degrees. For a LCD TV panel with 4k resolution, it is suggested that a distance for view is 1.5 H and this can achieve a better viewing effect, where H is the height of the display panel. The viewing angle in this circumstance is 60 degrees, as shown in FIG. 1.

However, it is inevitable to increase the number of pixels in the display panel and the number of thin-film transistors (TFTs) becomes large as well when the pixel size is reduced for improving the resolution of the display panel. If the number of pixels arranged in a horizontal direction grows, overlapped portions of gate lines and source lines increase and this makes the capacitance become larger. Also, this may aggravate a RC delay occurred on gate electrodes and thus affect signal transmission. If the number of pixels arranged in a vertical direction grows, a charging time of a capacitor in a single pixel is shortened. These factors greatly affect image displaying quality and stability.

### SUMMARY OF THE INVENTION

An objective of the present invention is to provide a display panel, for solving the problem of circuit instability caused by disposing a large number of pixels on a high-resolution display panel.

Another objective of the present invention is to provide display panel, for reducing the number of pixels required in a high-resolution display panel and meanwhile keeping the visual perception of human eyes unaffected.

To achieve the above objectives, the present invention provides a display panel, having a substrate that has a plurality of pixels disposed thereon for displaying images according to image data signals, characterized in that: the display panel is divided into a central region and a peripheral region; the central region is located at a central position of the substrate, the central region is extended outward from the central position of the substrate and occupies a predetermined area; and the peripheral region surrounds the central region; wherein the pixels located in the central region are of the same size and the pixels located in the peripheral region become larger and larger in size along a direction away from the central region.

According to an embodiment of the present invention, the central region occupies a half width of the display panel with respect to a horizontal direction, the peripheral region is immediately adjacent to the central region and is extended to two sides of the display panel in the horizontal direction.

According to an embodiment of the present invention, the pixels located at the two outermost sides of the display panel are 1.1 to 1.5 times as wide as the pixels located in the central region.

According to an embodiment of the present invention, the pixels located at the two outermost sides of the display panel are 1.15 times as wide as the pixels located in the central region.

In another aspect, the present invention provides a display panel, having a substrate that has a plurality of pixels disposed thereon for displaying images according to image data signals, characterized in that: the display panel is divided into a central region and a peripheral region; the central region is located at a central position of the substrate, the central region is extended outward from the central position of the substrate and occupies a predetermined area; and the peripheral region surrounds the central region; wherein a distribution density of the pixels located in the central region is greater than that of the pixels located in the peripheral region.

According to an embodiment of the present invention, the pixels located in the central region are of the same size and the pixels located in the peripheral region become larger and larger in size along a direction away from the central region.

According to an embodiment of the present invention, the central region occupies a half width of the display panel with respect to a horizontal direction, the peripheral region is immediately adjacent to the central region and is extended to two sides of the display panel in the horizontal direction.

According to an embodiment of the present invention, the pixels located at the two outermost sides of the display panel are 1.1 to 1.5 times as wide as the pixels located in the central region.

According to an embodiment of the present invention, the pixels located at the two outermost sides of the display panel are 1.15 times as wide as the pixels located in the central region.

In yet another aspect, the present invention provides a display panel, characterized in that: the display panel is divided into at least two regions from the inside out and the at least two regions are respectively defined as a first region and a second region; the first region is a central region located at a central position of the display panel, the first region comprises a plurality of first pixels that are of the same size; and the second region surrounds the first region, the second region comprises a plurality of second pixels that are of different sizes; wherein the second pixels of the second region become larger and larger in size along a direction away from the first region.

According to an embodiment of the present invention, the first region occupies a half width of the display panel with respect to a horizontal direction, the second region is immediately adjacent to the first region and is extended to two sides of the display panel in the horizontal direction.

According to an embodiment of the present invention, the pixels located at the two outermost sides of the display panel are 1.1 to 1.5 times as wide as the pixels located in the first region.

According to an embodiment of the present invention, the pixels located at the two outermost sides of the display panel are 1.15 times as wide as the pixels located in the first region.

Based on different visual perception of human eyes for different fields of view, the present invention utilizes such a characteristic to make the pixel distribution density of the central region unchanged, and on the other hand, make the pixel distribution density of the peripheral region decreased. By this way, the present invention can effectively reduce the number of pixels required in a high-resolution display panel and thus solve the problem of circuit instability caused by disposing a large number of pixels on the high-resolution display panel.

To make above content of the present invention more easily understood, it will be described in details by using preferred embodiments in conjunction with the appending drawings.

### BRIEF DESCRIPTION OF THE DRAWINGS

FIG. 1 is a schematic diagram showing a display screen provided for a viewer.

FIG. 2 is a schematic diagram showing different fields of view under different sensibility of human eyes.

FIG. 3 is a schematic diagram showing a display panel according to the present invention.

FIG. 4 is a schematic diagram showing a display panel along a width direction according to an embodiment of the present invention.

FIG. 5 is a schematic diagram showing a pixel size of a display panel along a width direction according to an embodiment of the present invention.

### DETAILED DESCRIPTION OF THE INVENTION

The following descriptions for the respective embodiments are specific embodiments capable of being implemented for illustrations of the present invention with referring to appended figures. In the descriptions of the present invention, spatially relative terms, such as “upper”, “lower”, “front”, “back”, “left”, “right”, “top”, “bottom”, “horizontal”, “vertical”, and the like, may be used herein for ease of description as illustrated in the figures. Therefore, it will be understood that the spatially relative terms are intended to illustrate for understanding the present invention, but not to limit the present invention.

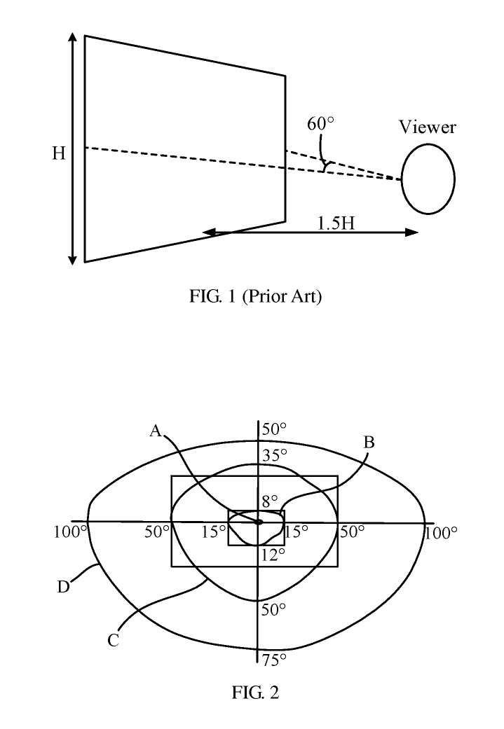

Referring to FIG. 2, the sensibility of human eyes differs from different fields of view. In general, according to different visual perception, it can be classified into a resoluble field of view (A), an effective field of view (B), an inductive field of view (C), and an auxiliary field of view (D), sequentially.

Based on different visual perception of human eyes for different fields of view, the present invention utilizes such a characteristic to arrange the distribution density of pixels on a display panel. The pixel distribution density is high in an area where the visual perception is relatively high. The pixel distribution density is low in an area where the visual perception is relatively low. By this way, the present invention can effectively reduce the number of pixels required in a high-resolution display panel and thus can maintain the image displaying stability.

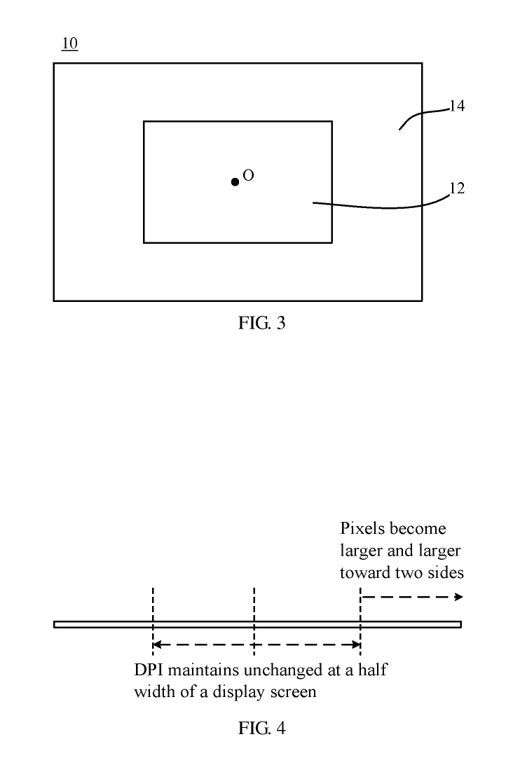

Referring to FIG. 3, the display panel 10 of the present invention has a substrate (not shown). The substrate has a plurality of pixels disposed thereon for displaying images according to image data signals. The display panel 10 can be divided into at least two regions from the inside out. In this embodiment, two regions (i.e., a first region 12 and a second region 14) are illustrated for example but the present invention is not limited thereto. The display panel 10 also can be divided into three, four, or more regions. Each region may be a rectangle or square but the present invention is not limited thereto. The shape of each region also can be any geometric shape.

The first region 12 is a central region located at a central position O of the display panel 10. The central region 12 is extended outward from the central position O and occupies a predetermined area. For example, the central region 12 occupies a half width of the display panel 10 with respect to a horizontal direction and occupies a half height of the display panel 10 with respect to a vertical direction.

The second region 14 is a peripheral region that surrounds the central region 12. In a specific embodiment, the peripheral region 14 is immediately adjacent to the central region 12 as shown in FIG. 3. In another specific embodiment, another region occupying a certain area may exist between the central region 12 and the peripheral region 14. In the embodiment where the display panel 10 is divided into the two regions, the peripheral region 14 is extended to two lateral sides of the display panel 10 in the horizontal direction and is extended to an upper edge and a lower edge of the display panel 10 in the vertical direction. It is noted that the peripheral region indicated in the present invention is not defined as the outermost region of the display panel but actually is defined as a region able to surround the central region.

In the present invention, the distribution density of the pixels located in the central region 12 of the display panel 10 is designed to be greater than that of the pixels located in the peripheral region 14. That is to say, the pixel distribution density differs from different regions.

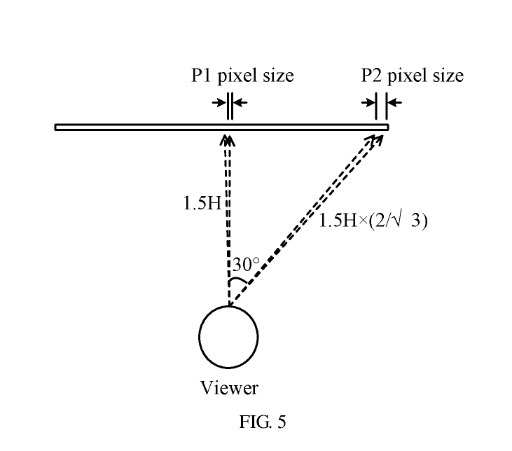

For example, in an implementable technical scheme, the pixels located in the central region 12 are of the same size but the pixels located in the peripheral region 14 become larger and larger in size along a direction away from the central region 12, as shown in FIG. 4. That is to say, DPI (dot per inch) of the central region 12 maintains unchanged but the DPI of the peripheral region 14 become smaller and smaller along a direction away from the central region 12.

That is to say, the central region 12 comprises a plurality of first pixels that are of the same size and the peripheral region 14 comprises a plurality of second pixels that are of different sizes. The second pixels of the peripheral region 14 become larger and larger in size along a direction away from the central region 12.

Based on different visual perception of human eyes for different fields of view, the present invention utilizes such a characteristic to make the pixel distribution density of the central region unchanged, and on the other hand, make the pixel distribution density of the peripheral region decreased. By this way, the present invention can effectively reduce the number of pixels required in a high-resolution display panel and thus solve the problem of circuit instability caused by disposing a large number of pixels on the high-resolution display panel.

Referring to FIG. 4 and FIG. 5, take a LCD TV panel with a resolution of 4K×2K for illustration. In one specific embodiment, the central region occupies a half width of the display panel. The peripheral region is immediately adjacent to the central region and is extended to the two outermost sides of the display panel in the horizontal direction. The central region of the display panel still maintains the original DPI. That is, the size of each pixel in the central region is not changed. However, the pixels located in the peripheral region gradually become larger and larger from inside to outside.

In an aspect of product design, a best distance for view is 1.5H (where H is the height of the display panel). The width of the display panel happened to be a 60-degree viewing angle when a viewer is at 1.5H away from the display panel. As the viewer watches the pixels located at different positions of a display screen, the visual ability or sensibility of human eyes can be represented by:

f=arctan(p/D)

where p is the width of a pixel and D is the distance from the human eyes to the display screen. As can be seen, the proportion of the sensibility at the central position to the sensibility at the two sides of the display screen is 0.5×√3. If a pixel width P2 at the two sides of the display screen is changed to 2/√3 (≅1.15) times as much as the pixel width P1 at the central position of the display screen, the sensibility at these two locations can be consistent with each other. In practical applications, it is permissible that the pixels located at the two outermost sides are 1.1 to 1.5 times as wide as the pixels located in the central region, however, 1.15 times may be preferred.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A display panel, having a substrate that has a plurality of pixels disposed thereon for displaying images according to image data signals, characterized in that:
the display panel is divided into a central region and a peripheral region;
the central region is located at a central position of the substrate, the central region is extended outward from the central position of the substrate and occupies a predetermined area; and
the peripheral region surrounds the central region;
wherein the pixels located in the central region are of the same size and the pixels located in the peripheral region become larger and larger in size along a direction away from the central region.

2. The display panel according to claim 1, wherein the central region occupies a half width of the display panel with respect to a horizontal direction, the peripheral region is immediately adjacent to the central region and is extended to two sides of the display panel in the horizontal direction.

3. The display panel according to claim 2, wherein the pixels located at the two outermost sides of the display panel are 1.1 to 1.5 times as wide as the pixels located in the central region.

4. The display panel according to claim 3, wherein the pixels located at the two outermost sides of the display panel are 1.15 times as wide as the pixels located in the central region.

5. A display panel, having a substrate that has a plurality of pixels disposed thereon for displaying images according to image data signals, characterized in that:
the display panel is divided into a central region and a peripheral region;
the central region is located at a central position of the substrate, the central region is extended outward from the central position of the substrate and occupies a predetermined area; and
the peripheral region surrounds the central region;
wherein a distribution density of the pixels located in the central region is greater than that of the pixels located in the peripheral region.

6. The display panel according to claim 5, wherein the pixels located in the central region are of the same size and the pixels located in the peripheral region become larger and larger in size along a direction away from the central region.

7. The display panel according to claim 6, wherein the central region occupies a half width of the display panel with respect to a horizontal direction, the peripheral region is immediately adjacent to the central region and is extended to two sides of the display panel in the horizontal direction.

8. The display panel according to claim 7, wherein the pixels located at the two outermost sides of the display panel are 1.1 to 1.5 times as wide as the pixels located in the central region.

9. The display panel according to claim 8, wherein the pixels located at the two outermost sides of the display panel are 1.15 times as wide as the pixels located in the central region.

10. A display panel, characterized in that:
the display panel is divided into at least two regions from the inside out and the at least two regions are respectively defined as a first region and a second region;
the first region is a central region located at a central position of the display panel, the first region comprises a plurality of first pixels that are of the same size; and
the second region surrounds the first region, the second region comprises a plurality of second pixels that are of different sizes;
wherein the second pixels of the second region become larger and larger in size along a direction away from the first region.

11. The display panel according to claim 10, wherein the first region occupies a half width of the display panel with respect to a horizontal direction, the second region is immediately adjacent to the first region and is extended to two sides of the display panel in the horizontal direction.

12. The display panel according to claim 11, wherein the pixels located at the two outermost sides of the display panel are 1.1 to 1.5 times as wide as the pixels located in the first region.

13. The display panel according to claim 12, wherein the pixels located at the two outermost sides of the display panel are 1.15 times as wide as the pixels located in the first region.
